(19) United States
(12) Patent Application Publication
(10) Pub. No.: US 2025/0155880 A1
(43) Pub. Date: May 15, 2025

(54) Method of Scheduling Resources in an Industrial Process, Computer-Implemented Scheduling System, and Computer Program Product

(71) Applicant: ABB Schweiz AG, Baden (CH)

(72) Inventors: Shrikant Bhat, Bangalore (IN); Ulaganathan Nallasivam, Bangalore (IN)

(73) Assignee: ABB Schweiz AG, Baden (CH)

(21) Appl. No.: 19/026,994

(22) Filed: Jan. 17, 2025

Related U.S. Application Data
(63) Continuation of application No. PCT/EP2023/069950, filed on Jul. 18, 2023.

(30) Foreign Application Priority Data
Jul. 19, 2022 (IN) 202241041298

(51) Int. Cl. G05B 19/418

(52) U.S. Cl. CPC G05B 19/41865; G05B 19/41885

(57) ABSTRACT

A method for scheduling resources in an industrial process includes generating a model of the industrial process, and simulating the industrial process in the model. Simulating the industrial process in the model includes operations a) through e): a) determining an initial state as the current state of the industrial process model; b) selecting an allowable action from a group of possible actions for a resource; c) determining an updated state based on the selected action, and setting the current state as the updated state; d) repeating operations b) through c) until a final state is reached; and e) evaluating the updated states and/or the final state according to a predefined evaluation function.

### CROSS-REFERENCE TO RELATED APPLICATIONS

The instant application claims priority to International Patent Application No. PCT/EP2023/069950, filed Jul. 18, 2023, and to Indian Patent Application number 202241041298, filed Jul. 19, 2022, each of which is incorporated herein in its entirety by reference.

### FIELD OF THE DISCLOSURE

The instant disclosure generally relates to scheduling process cycles of an industrial process and, more particularly, modelling and simulating the industrial process by selecting allowable actions of resources.

### BACKGROUND OF THE INVENTION

Scheduling optimization in process industries poses challenges due to complexity in modeling the underlying system. This is mainly due to involvement of both continuous and discrete variables often leading to a complex non-linear mixed integer linear programming formulation.

Such approaches have often led to issues with scalability of such solutions. Formulating an optimization problem of a complex process may be challenging to a human operator. Furthermore, the optimization may be computationally challenging. There are approaches based on reinforcement learning that are promising to overcome this problem. However, the scalability in such cases is dependent on the ease of modeling the underlying process components from scheduling perspective in a generic way. While there are general purpose discrete event simulation tools available, there are issues with generalizing such approaches across various domains in process industries which have typical common attributes related to, for example, phase sequencing, overlaps, material, and energy balance.

### BRIEF SUMMARY OF THE INVENTION

Based on the foregoing, there is a need for a domain-agnostic solution for scheduling optimization that is applicable even for complex industrial processes. According to an aspect, a method of scheduling resources in an industrial process is described. The industrial process includes resources comprising primary resources. The primary resources are associated with a production cycle of the industrial process. The method includes generating a model of the industrial process, and simulating the industrial process in the model. Simulating the industrial process in the model includes operations a) through e): a) determining an initial state as the current state of the industrial process model; b) selecting an allowable action from a group of possible actions for a resource; c) determining an updated state based on the selected action, and setting the current state as the updated state; d) repeating operations b) through c) until a final state is reached; and e) evaluating the updated states and/or the final state according to a predefined evaluation function.

According to an aspect, a computer-implemented scheduling system for scheduling a process cycle of an industrial process is described. The scheduling system includes a user interface and a software that, when executed on the scheduling system, causing the scheduling system to perform a method according to embodiments described herein.

According to an aspect, an industrial process is described. The industrial process includes resources. A resource may be a component, device or machine associated with the industrial process for carrying out production operations or value addition in general. While performing an operation, the resource is in a state associated with the operation. States may be entered by performing actions. Resources may perform e.g. material handling, transport, storage and/or processing. Examples of resources include, but are not limited to, digesters, such as paper pulp digesters, mills, such as cement mills, conveyors, silos, energy or steam suppliers, ladles, cranes, furnaces, such as electric arc furnaces, dig sites, crushers, and loaders. While the present disclosure is described in the context of exemplary industrial fields such as pulp and paper processing, cement processing, metal smelting or mining, the disclosure is equally applicable to further industrial fields such as e.g. food production and processing, machining or other types of part production, harvesting, waste processing or logistics. Beneficially, the methods and systems described herein may be applicable to both batch industrial processes and continuous industrial processes.

An industrial process includes at least one production cycle. A production cycle may be understood as a sequence of phases that lead to desired outcome with certain expected value addition. An industrial process may consist of a single production cycle. An industrial process may comprise one or more production cycles, such as a series of production cycles, and/or several production cycles operating, e.g., sequentially or in parallel. Scheduling resources in an industrial process may relate to scheduling resources in a production cycle, or even scheduling resources in more than one production cycle.

According to an aspect, resources comprise primary resources. A primary resource is associated with all the steps of a production cycle of the industrial process. For example, a primary resource, when operating in the production cycle, may define, while operating, the possible actions of other resources of the production cycle. A primary resource may be a resource that is required to initiate a production cycle. A primary resource may determine the number of parallel production cycles. A primary resource may be required to operate according to constraints. For example, a primary resource may be a processor for processing a material, and processing the material according to given constraints, e.g. fully processing the material to obtain a desired state, may be required for the production cycle to proceed. An industrial process may include at least one primary resource. According to embodiments, some industrial processes may be modelled having only primary resources.

According to an aspect, resources comprise secondary resources. A secondary resource has at least one state associated with a production cycle of the industrial process, and at least one state not associated with the production cycle. A secondary resource, in a state not associated with the production cycle, may operate independently of the production cycle and/or not affect the scheduling or operation of the production cycle. A secondary resource, in a state associated with the production cycle, may include supporting a production phase, for example by supplying material or energy to a primary resource, and/or performing intermittent operations, such as transporting. For example, in a ladle smelting process, a crane for transporting ladles or an electric arc furnace may be secondary resources, while the ladle holding the material to be processed may be a primary resource.

According to an aspect, a method of scheduling resources in the industrial process includes generating a model of the industrial process. Generating a model may include defining parameters of the industrial process, such as resources of the industrial process. Generating the model may include linking resources, such as primary and secondary resources. Generating the model may include defining a sequence of phases of the industrial process. Generating the model and/or linking may include defining possible actions depending on a state of the model. Generating the model and/or linking may include defining possible states of the model, particularly defining possible states and/or actions of resources of the industrial process. Generating the model may include defining feasible states of the model, particularly defining feasible states of a resource depending on a state of another resource. A feasible state may be a state that is not forbidden. A forbidden state may be a state that cannot be entered due to logical or physical constraints. Examples for forbidden states include, but are not limited to: a processor may not simultaneously process different types of material, a crane in transit may not be loaded, and/or different processors may not be simultaneously supplied with raw material from the same conveyor.

### BRIEF DESCRIPTION OF THE SEVERAL VIEWS OF THE DRAWING(S)

FIG. 1 is a flowchart for a method in accordance with the disclosure.

FIG. 2A is a schematic of an industrial process including pulp digesters in accordance with the disclosure.

FIG. 2B is a simulation result schedule of a scheduling method according to embodiments of the present disclosure.

FIG. 3 is a block diagram of an industrial process for cement production in accordance with the disclosure.

FIG. 4 is a diagram of a simulation optimization process according to embodiments of the present disclosure.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. Generally, only the differences with respect to the individual embodiments are described. Unless specified otherwise, the description of a part or aspect in one embodiment applies to a corresponding part or aspect in another embodiment as well.

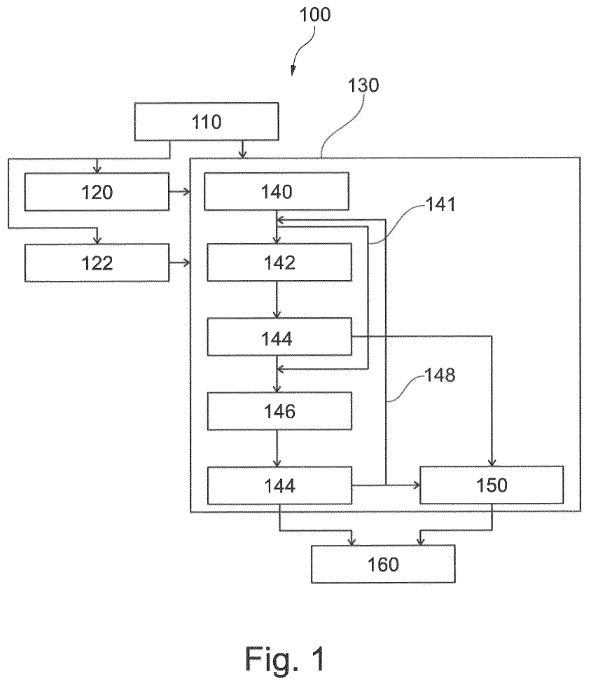

Referring now to FIG. 1, a method 100 of scheduling resources in an industrial process according to embodiments is described. In operations 110, 120 and 122, a model of the industrial process is generated. Generating the model may include providing an operator input.

In operation 110, simulation parameters are defined. According to embodiments, the simulation parameters may include constraints. Simulation parameters may be associated with a resource of the process. Simulation parameters may be associated with constraints of a resource, or even the whole industrial process, such as limits regarding raw material or power availability. Constraints may be related to resource capacity and availability, particularly in the case of shared resources, limits of resources or the production cycle or industrial process as a whole, and/or production targets. Simulation parameters may include parameters such as resource capacity, processing times of a resource, parameters relevant to material and energy balance of a resource, or the like.

According to embodiments, the parameters may be stored in a parameter matrix. In the context of this disclosure, a matrix is to be understood as any kind of data structure suitable for storing values and representing relationships between values, such as associating parameters and/or constraints with resources of the process.

In operation 120, resource states and actions are defined. According to embodiments, resource states for resources associated with the industrial process are defined. In particular, for each resource, each possible state of the resource may be defined. A resource state may be understood as a state that may define the resource in a scheduling context. Examples for resource states of an exemplary processing resource include, but are not limited to, loading, unloading, heating, cooling, processing, cleaning, waiting. States unrelated to scheduling, such as, for example, colour, maintenance requirements or manufacturing date of a machine represented by a resource, unless relevant for scheduling, are not considered states of the resource.

According to embodiments, a resource state may be dynamic or static. A static state may be a state in which the existing state carries forward to the next time step or iteration. Accordingly, in a static state, no further actions may be allowed unless a predefined time period has expired and/or conditions for the transition into another state are met. An example for a static state of an exemplary processing resource may include processing a loaded material for a given amount of time, or continuously heating a material until a target temperature is reached. A dynamic state may be a state in which different actions are possible. In particular, for a resource in a dynamic state, multiple actions may be available for transitioning to a new state.

According to embodiments, resource actions (“actions”) are any action that may be performed by the resource. Actions, in the context of the disclosure, may be defined as transitioning from one state of the resource into another state. Actions may be associated with a state of the resource. For example, a static state may not be associated with any actions, or only be associated with an action defined as continuing the static state. For example, dynamic states may allow several actions to be performed, i.e. several states to be entered originating from the dynamic state. Accordingly, for each resource in a dynamic state, the actions associated with the dynamic state may be considered a group of possible actions.

According to embodiments, states and actions associated with a resource may be represented in a state and action matrix. In the context of this disclosure, a matrix is to be understood as any kind of data structure suitable for storing values and representing relationships between values, such as actions associated with states. The state and action matrix may allow a simulator to determine possible actions of a resource for each state of the resource.

In operation 122, a feasibility of states is defined. According to embodiments, operation 122 includes defining states of a resource that are not allowed to co-exist, i.e. be entered at the same process interval and/or in the same time period. Operation 122 may include defining, for several or all states of several or all resources, states that may not be entered, depending on the state of another resource. For example, the feasibility of states may be derived from constraints involving phase or interval overlaps that are not possible due to resource or operational constraints.

According to embodiments, the feasibility of states may be represented in a feasibility matrix. The feasibility matrix may define forbidden states of a first resource depending on a state of a second resource. Accordingly, the feasibility matrix may define forbidden actions, i.e. actions that would result in a forbidden state. In the context of this disclosure, a matrix is to be understood as any kind of data structure suitable for storing values and representing relationships between values, such as states that are not allowed to co-exist. The feasibility matrix, in combination with the state and action matrix, may allow a simulator to determine a group of allowable actions of a resource from a group of possible actions. The group of allowable actions may be a subset of the group of possible actions.

According to embodiments, generating a model of the industrial process may include generating a parameter matrix for a number of resources, generating a state and action matrix for a number of resources, and generating a feasibility matrix for a number of resources. Beneficially, process topologies may be represented in the model via one or more of the matrices, particularly the state and action matrix and/or the feasibility matrix. Beneficially, process constraints may be represented in the model via one or more of the matrices, particularly the parameter matrix and the feasibility matrix. Accordingly, the model used for simulating the process may be based on computationally simple data structures, thus simplifying simulation and/or reducing computational load. Furthermore, the model used for simulating the industrial process is highly flexible and process type agnostic, and may be suitable for modelling various types of industrial processes.

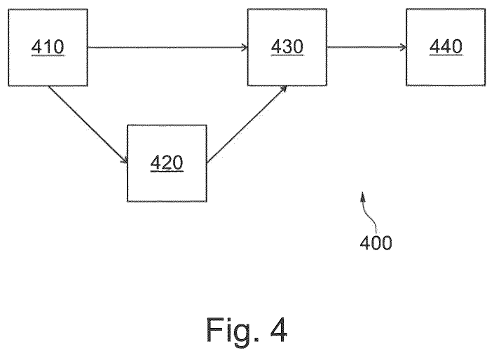

As shown in FIG. 1, the data generated in operations 110, 120, 122 is used for simulating 130 the industrial process in the model. Simulating 130 may be performed in a simulator, such as simulator 440 described herein with reference to FIG. 4.

In operation 140, an initial state of the industrial process model is determined. The initial state may include and/or define a state for each resource included in the simulation. The initial state may be determined by defining a state corresponding to a starting situation of the industrial process on which the scheduling operation is based, and/or for which the scheduling of resources shall be optimized. Determining the initial state may result in a current state of the model being defined. Determining the initial state may include providing an operator input, or may be automated. In a typical example, an initial state may be definable as all resources being in a “waiting” state, which may be considered a default initial state. In a further example, the scheduling method may be performed to optimize the industrial process under given starting conditions, and the starting conditions may be represented in the initial state. For a batch process, an initial state representing a starting condition, or an intermediate condition of the batch process may be determined. Accordingly, for optimizing a continuous process, an initial state representing the industrial process during starting conditions, intermediate conditions, or even optimal running conditions may be chosen. During operation 140, an initial time point or iteration of the simulation may be set as 0.

As shown in FIG. 1, for simulating 130 an industrial process including secondary resources, operation 142 is performed. According to embodiments, particularly for simulating a model having no secondary resources, operation 142 may be skipped, as indicated by the arrow 141 shown in FIG. 1, and the process may continue with operation 146. Actions of secondary resources may be selected before actions of primary resources are selected.

In operation 142, an allowable action from a group of possible actions for a secondary resource is selected. The allowable action may be selected randomly. According to embodiments, selecting an allowable action includes selecting a secondary resource, particularly randomly selecting a secondary resource, randomly selecting a possible action from the group of possible actions for the selected resource, and checking if the selected possible action is feasible, i.e. if selecting the possible action would result in a feasible state. A possible action that is not forbidden is feasible. A possible action that is forbidden is not feasible and is not an allowable action. Randomly selecting an allowable action may include utilizing data generated when generating the model in operations 110, 120 and 122, as well as the initial state generated in operation 140, or the current state generated in operation 144. (Randomly) selecting the allowable action may include evaluating the parameter matrix, the state and action matrix, and/or the feasibility matrix.

In operation 146, an allowable action from a group of possible actions for a primary resource is selected. The allowable action may be selected randomly. According to embodiments, selecting an allowable action includes selecting a primary resource, particularly randomly selecting a primary resource, randomly selecting a possible action from the group of possible actions for the selected resource, and checking if the selected possible action is feasible, i.e. if selecting the possible action would result in a feasible state. A possible action that is not forbidden is feasible. A possible action that is forbidden is not feasible and is not an allowable action. (Randomly) selecting an allowable action may include utilizing data generated when generating the model in operations 110, 120 and 122, as well as the initial state generated in operation 140, or the current state generated in operation 144. (Randomly) selecting the allowable action may include evaluating the parameter matrix, the state and action matrix, and/or the feasibility matrix.

In operation 144, a current state is set. Depending on the preceding operation, as shown in FIG. 1, operation 144 may be executed following the selecting an allowable action of either a primary resource or a secondary resource. Setting the current state includes determining an updated state, and setting the current state as the updated state. Determining an updated state may include determining the state of the resource following the selection of the allowable action of the resource, and may further include determining the state of further resources depending on the state of the resource for which the allowable action was selected.

According to embodiments, an updated state may be a final state. Accordingly, the current state may be set as the updated state and be a final state. A final state may be a state in which a predefined condition is met. For example, a final state may be a state in which a predefined operation parameter or process target is reached, such as, but not limited to, having completed parallel or sequential batch processes and/or having processed a desired amount of material. Likewise, a final state may be a state in which simulation constraints have been reached or exceeded, such as, but not limited to, having repeated one or more operations of the simulation for a predefined number of iterations and/or time periods.

As shown by arrow 148, operations 142, 144 and 146 may be repeated until a final state is reached, i.e. the simulating 130 may include repeatedly selecting an allowable action for a resource and determining an updated state. For each iteration, a different selection of an allowable action is performed. According to embodiments, the selection of the allowable action may be random, at least in states in which resources are in a dynamic state.

According to embodiments, an iteration may correspond to a time period t. In particular, a number of iterations may correspond to the time period t. For example, if the model has n resources, a number of iterations m≤n may be performed for each time period. In particular, an allowable action for each resource within the time period may be selected for the corresponding time period, particularly so that an allowable action is selected for each resource in the time period. Once an allowable action has been selected for each resource in the time period, the following iteration(s) may correspond to a time period t+1. If every resource is in a dynamic state, then m may be equal to n. If one or more resources are in a static state, i.e. do not allow selecting an allowable action other than remaining in the static state, then m may be smaller than n, or even 1, and the simulation may be optimized accordingly, i.e. require a lower number of iterations for the time period. A time period may correspond to a timespan defining the industrial process in sufficiently high resolution. For example, for the industrial processes described herein, a time period may correspond to a timespan of 1 minute, 2 minutes, 3 minutes, 5 minutes, 10 minutes or even more than 10 minutes. The process may be simulated for a number of time periods corresponding to the optimization problem, which may, in a batch-type process, typically correspond to the time to process a number of batches, such as 1 batch, 2 batches, 3 batches, 5 batches or even 10 batches. For example, for the industrial processes described herein, a final state may be defined as being reached after 10 to 1000 time periods, particularly 20 to 500 time periods, 50 to 500 time periods, or even 100 to 200 time periods, such as 150 time periods.

As shown in FIG. 1, following operation 144, e.g. the updating of the state in operation 144, the state may be evaluated in operation 150. Operation 150 includes evaluating the updated states and/or the final state according to a predefined evaluation function. Operation 150 may be performed after each determining of an updated state. Likewise, performing operation 150 for the updated states during the simulation, i.e. in updated states that are not a final state, may be optional. Accordingly, in some embodiments, operation 150 may be performed for none or only some of the updated states, and be performed, for example, for the final state, such as only for the final state.

According to embodiments, the evaluation function is a function suitable for determining a simulation result for the updated and/or final state. Determining a simulation result may include scoring the simulation result, particularly scoring the simulation result according to key performance indicators (“KPIs”), rewards and/or penalties. The simulation result may be calculated by a predefined evaluation function. The predefined evaluation function may perform the scoring according to the KPIs, rewards and/or penalties. The predefined evaluation function may evaluate the simulation result according to predefined objectives. For example, a predefined objective may include optimizing scheduling of the industrial process according to one or more specific desires, such as reducing peak energy consumption, regulating energy consumption according to variable energy costs, improving transport logistics, preventing downtime of one or more resources, optimizing yield or material output, or the like. Accordingly, the predefined evaluation function may score the state according to the objective, e.g. provide a higher score for arriving at a schedule in accordance with the objective than for a schedule not in accordance with the objective.

According to embodiments, the evaluation function may provide a result, such as a score. The evaluation function may include evaluating the state according to, for example, but not limited thereto, energy consumption, material consumption, processed material output and/or time required to achieve a predefined result, such as arriving at a desired production yield or processing a predefined amount of starting material.

As shown in FIG. 1, the method may include generating an output 160. Typically, data generated during iterations of the simulating 130 may be stored, and an output based on the data may be generated based on the stored outputs. A schedule may be generated, based on the selections of actions for the resources, and/or based on the updated states. According to embodiments, the simulating 130 may be performed for a number of iterations until the final state is reached, and in operation 160, the result schedule and the simulation result and/or score of at least the final state and optionally one or more (intermittent) updated states may be evaluated, stored, presented to an operator and/or further analysed.

According to embodiments, the method 100 shown in FIG. 1, as described above, may be suitable for generating a simulation of an industrial process or process cycle. In some embodiments, the simulation is based on random selections of actions for resources. Accordingly, different simulations, having different random selections of actions, may result in different schedules having different scores.

According to embodiments, the method 100 may be repeated for a predefined number of repeats. In particular, the method 100 may include repeatedly simulating 130 the industrial process for a number of repeats. Each repeat may include generating an output, e.g. a result schedule and a simulation result, in operation 160 after performing a predefined number of iterations and/or time periods. The output may include records of the randomly selected allowable actions, which may define the result schedule. The method 100 may include, for each repeat, evaluating the state, particularly the final state, corresponding to the result schedule, as described for operation 150. The method 100 may include selecting an optimized result schedule based on a result of the evaluation function. According to embodiments, the method may be repeated for more than 1,000 repeats, more than 10,000 repeats, or even more than 100,000 repeats.

According to embodiments, when repeating the method 100, generating the model of the industrial process in operations 110, 120 and 122, and even determining the initial state 140, may beneficially be performed only once, e.g. during setup and/or initialization. Accordingly, repeating the method 100 for a predefined number of times may be performed by repeatedly simulating 130 and generating an output 160. This may provide the same starting conditions for each round of simulation, which may beneficially result in scheduling results that are comparable, e.g. according to the result of the evaluation function. Beneficially, repeating the method 100 may result in a set of outputs including schedules based on variable selected actions, each schedule having a defined simulation result and/or score.

According to embodiments, the simulation may be utilizable in, or describable as, a type of stochastic method, such as Markov decision process, particularly by repeatedly simulating the industrial process in the model, such as described above. For example, a predefined number of outputs may be generated, and an output having a high score, i.e. an output conforming to the optimization problem as defined by the evaluation function, may be selected. Beneficially, in some use cases, optimized or even near-perfect scheduling results may be obtainable without deterministically modelling the underlying system or fully defining the underlying objective. Beneficially, groups of outputs having high scores may be suitable for identifying patterns and/or trends in the schedule that result in optimized schedules.

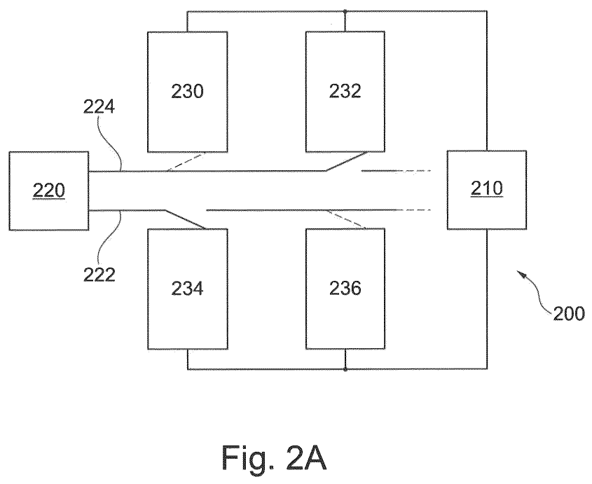

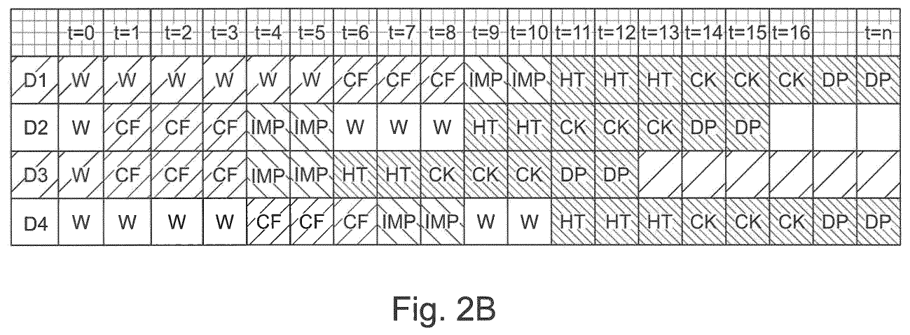

Referring now to FIG. 2A and FIG. 2B, an exemplary batch-based pulp production process, and a simulation and simulation result thereof is described. The simulation may be performed according to the method 100 described with respect to FIG. 1. The simulation result, i.e. the schedule shown in FIG. 2B, may be a high-scoring and/or optimized result after repeatedly simulating the production cycle according to method 100. The paper production process includes a production cycle 200 for pulp production, having four digesters 230, 232, 234 and 236, a storage facility for wood chips 220, two conveyors 222 and 224 for transporting wood chips to the digesters, and a steam source 210 for providing steam to the digesters 230, 232, 234, 236 to heat the contents of the digesters.

The conveyor belts 222, 224 may only provide wood chips to either one of the connected digesters, i.e. digesters 230, 232 may not be filled simultaneously, and digesters 234, 236 may not be filled simultaneously.

The production cycle 200 further includes lines for filling the digesters with liquor (not shown) and facilities for displacement (DP) and discharge (DC). The filling lines have the same constraints as the conveyor belts 222, 224, i.e. the digesters 230, 232 may not be filled simultaneously, and the digesters 234, 236 may not be filled simultaneously.

The model is defined by the following data, represented in Tables 1 to 4.

The scheduling optimization problem is stated in the following Table 1.

TABLE 1

| Item | Details |
|---|---|
| Time horizon | 150 time units |
| Objective | Minimizing steam fluctuations and reducing |
| | makespan for given production target |
| Constraints | Production target; Bounds on tank levels; No |
| | phase overlap for digesters in a line |
| No of lines | 2 |
| Digester configuration | Line 1: D1, D2 |
| | Line 2: D3, D4 |
| Production Cycle | Chip filling (CF); Impregnation liquor filling |
| | (IMP); Wait; Heating (HT); Cooking (CK); |
| | Displacement (DP); Wait; Discharge(DC); |
| | Wait |

As defined in Table 1, the primary resources of the industrial process model are the digesters 220, 222, 224, 226. The industrial process model does not include secondary resources.

A state and action matrix is defined in Table 2.

TABLE 2

| Digester states | Type | Action Matrix |
|---|---|---|
| Digester in CF | Static | — |
| Digester in IMP | Static | — |
| Digester after | Dynamic | Wait, HT |
| completion of | | |
| IMP | | |
| Digester waiting | Dynamic | Wait, HT |
| after IMP | | |
| Digester at HT | Static | — |
| Digester at CK | Static | — |
| Digester at DP | Static | — |
| Digester at end | Dynamic | Wait, DC |
| of DP | | |
| Digester at DC | Static | |
| Digester at the | Dynamic | Wait, CF |
| end of DC | | |
| Digester waiting | Dynamic | Wait, CF |
| after DC | | |

A feasibility matrix is defined in Table 3 for digesters 1 and 2, corresponding to digesters 230, 232, and is identical for digesters 3 and 4, corresponding to digesters 234, 236 shown in FIG. 2A. As is evident from the feasibility matrix, due to constraints of the process cycle as described above, the two digesters 1 and 2 may not be filled simultaneously. This is indicated by the entry “1”.

TABLE 3

| | | | | | | |
|---|---|---|---|---|---|---|
| D1\D2 | CF | IMP | HT | CK | DP | DC |

| | | | | |
|---|---|---|---|---|
| CF | 1 | | | |
| IMP | | 1 | | |
| HT | | | | |
| CK | | | | |
| DP | | | 1 | |
| DC | | | | 1 |

Parameters for the simulation of the process 200 are shown in Table 4 in a generalized form, and may be chosen according to parameters of a physical industrial process to be simulated.

TABLE 4

| | |
|---|---|
| 1 | Time units for each phase for each digester |
| 2 | Material requirement at each phase |
| 3 | Material production at each phase |
| 4 | Initial material availability |
| 5 | Initial state of the digesters |

Referring now to FIG. 2B, based on the above data, a simulation according to the method 100 may result in a schedule as shown in FIG. 2B. The schedule shown in FIG. 2B may be an optimized schedule for solving the stated objective: “Minimizing steam fluctuations and reducing makespan for given production target”. In the initial state t=0, all digesters D1, D2, D3 and D4 are in a waiting state W.

In the initial state, all digesters D1 to D4 are in a “wait” state W. At timepoint t=1 until timepoint t=3, digesters D2 and D3 are in a chip filling state CF. It should be noted that, according to the feasibility matrix shown in Table 3, digesters D1 and D2, as well as digesters D3 and D4 are not being filled simultaneously. At timepoint t=4 to t=5, digesters D2 and D3 are in the state impregnator liquor filling IMP. Digester D1 remains in a waiting state W. At timepoint t=6, digester D3 begins a heating cycle HT, which, at later timepoints, proceeds as cooking cycle CK and displacement cycle DP. Likewise, digester D1 starts the heating cycle HT at timepoint t=11, digester D2 starts the heating cycle HT at timepoint t=9, and digester D4 starts the heating cycle HT at timepoint t=11. It should be noted that the additional waiting periods for digester D1 in periods t=4 to t=5, and digester 3 at timepoint t=6 to t=8, has resulted in a staggered beginning of states with high energy requirements, i.e. heating and cooking cycles HT and CK. Thereby, the stated problem of minimizing steam fluctuation, while simultaneously reducing a makespan for given production target is solved by optimized scheduling.

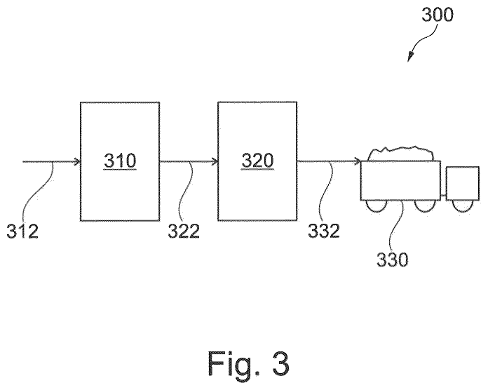

Referring now to FIG. 3, the modeling of an exemplary continuous cement production process is described to provide further understanding of the modeling procedure. In a simplified production cycle 300, raw materials 312 are provided to a cement mill 310 and processed in the cement mill 310. The processed materials are conveyed via conveyor 322 and stored in a silo 320 for further transport. When requested, the stored materials are dispatched, as shown by arrow 332, and moved, e.g. conveyed, onto a transporting vehicle, such as vehicle 330.

In the following example, several production cycles 300 are combined in a production process and modeled to be scheduled according to the method 100 described with reference to FIG. 1. The cycles may operate continuously for producing a specific grade of concrete. In the example, each production cycle should process the same grade at any point of time. Multiple power sources (not shown) are available for cement mills and conveyors with variable availability and time-dependent energy costs. The scheduling objective is to produce the required grade quantity while minimizing power requirements.

The model is defined by the following data, represented in Tables 5 to 8. The scheduling optimization problem is stated in the following Table 5.

TABLE 5

| | |
|---|---|
| Time horizon | 150 time units |
| Objective | Minimize energy cost |
| Constraints | Minimum/maximum consumption limits |
| | from each power supplier. Meeting |
| | production targets. |
| No of cement mills (CM); | 2; 3; 3; 4; 3 |
| Conveyor belts (CB); Silos | |
| (S); Power suppliers (P); | |
| No of grades (G) | |
| Production Cycle | Formulation in cement mill; conveying; |
| | storage; dispatch |
| Primary resource | CM; CB; S; P |
| Independent secondary resources | None |

It should be noted that in the example, no secondary resources are included in the model. However, according to embodiments, the simulation problem may be extended to include the dispatch of the processed material. In such embodiments, the vehicle 330 may be included in the simulation as a secondary resource, since the vehicle 330 is associated with the production process during e.g. a loading state, and not associated with the process in other states.

A state and action matrix is defined in Table 6. The state and action matrix includes states for each resource CM (cement mill 310), CB (conveyor 322), S (silo 320) and P (power supply, not shown).

TABLE 6

| CM states | Type | Action Matrix |
|---|---|---|
| CM after processing | Dynamic | Wait; Process grade A; B; C |
| grade A for minimum | | |
| time | | |
| CM after processing | Dynamic | Wait; Process grade A; B; C |
| grade B for minimum | | |
| time | | |
| CM after processing | Dynamic | Wait; Process grade A; B; C |
| grade C for minimum | | |
| time | | |
| CM processing grade A, | Static | — |
| B or C | | |
| CB states | Type | Action Matrix |
| CB after carrying grade | Dynamic | Wait; Process grade A; B; C |
| A from CM for minimum | | |
| time | | |
| CB after carrying grade | Dynamic | Wait; Process grade A; B; C |
| B from CM for minimum | | |
| time | | |
| CB after carrying grade | Dynamic | Wait; Process grade A; B; C |
| C from CM for minimum | | |
| time | | |
| CB carrying A, B, C to S | Static | — |
| S states | Type | Action Matrix |
| S with Grade A | Dynamic | Wait; Accept grade A |
| S with Grade B | Dynamic | Wait; Accept grade B |
| S with Grade C | Dynamic | Wait; Accept grade C |
| S empty | Dynamic | Wait; Accept grade A, B, C |
| S receiving grades A, B | Static | — |
| or C | | |
| P states | Type | Action Matrix |
| P1 supplying power | dynamic | P1-4 supplying power. |
| P2 supplying power | dynamic | P1-4 supplying power. |
| P3 supplying power | dynamic | P1-4 supplying power. |
| P4 supplying power | dynamic | P1-4 supplying power. |

A feasibility matrix is defined in Table 7 for the resources CM, CB, S and P. As can be seen in the table, forbidden states particularly include the mixing of different process grades in the cement mill 310, conveyor 322 and silo 320.

TABLE 7

| | CB | | |
|---|---|---|---|
| | Process | Process | Process |
| CM | grade A | grade B | grade C |
| Process grade A | | 1 | 1 |
| Process grade B | 1 | | 1 |
| Process grade C | 1 | 1 | |
| | CB | | |
| | Process | Process | Process |
| S | grade A | grade B | grade C |
| Receiving grade A | | 1 | 1 |
| Receiving grade B | 1 | | 1 |
| Receiving grade C | 1 | 1 | |

CM Any CM can process any grade
CB Any CB can carry any grade
S Any silo can receive any grade (governed by its past state and not by the state of other silos)
P All overlaps between power suppliers allowed.

Parameters for the simulation of the process 300 are shown in Table 8 in a generalized form, and may be chosen according to parameters of a physical industrial process to be simulated.

TABLE 8

| | |
|---|---|
| 1 | Minimum time a CM should process a specific grade |
| 2 | Power requirements by CM and CB for processing and transporting, |
| | respectively, a grade |
| 3 | Silo capacity and allowable min/max limits on the capacity |
| 4 | Production demand for each grade |
| 5 | Minimum and maximum power supply to be taken from each power |
| | vendor. Power tariff slabs. |

Tables 5 to 8 define a simulation problem. Accordingly, a simulation according to embodiments, e.g. as described with reference to FIG. 1, may result in an optimized process schedule.

According to an aspect, a model of the industrial process utilized in the simulation method described herein may be described as a hierarchical decision structure. Depending on the number of resources having dynamic states, the hierarchical decision structure may have a high number of possible paths. Accordingly, especially for complex models having a high number of possible paths, repeatedly performing the method and/or the simulation may not be feasible to arrive at an optimal process schedule, particularly if selecting the allowable actions is purely random. The above-stated problem may be solved, at least in part, by the following embodiments related to optimizing the simulation by an optimization procedure.

According to embodiments, the method 100 of scheduling resources in an industrial process described herein may be optimized by an optimization procedure. Optimization may be understood as reformulating the model used in the simulation, modifying the way the simulation is performed and/or reducing the computational load required for arriving at a simulation result, particularly a number of simulation results obtained by repeating a simulation. The optimization procedure may be integrated into a method of scheduling, such as the method 100 described with reference to FIG. 1.

While embodiments of the optimization procedure are described in the context of the methods of scheduling an industrial process according to embodiments described herein, the optimization procedure may be suitable for yet further methods of scheduling resources in an industrial process, particularly for stochastic methods, such as methods based on a Markov decision process.

According to embodiments, the optimization procedure may include identifying trends in data generated from one or more states of the industrial process model, including presenting the data to an operator. The operator may be a human, particularly an expert having an understanding of the industrial process being modelled. Rules are generated based on the identified trends. An operator input may be provided, e.g. for confirming the identified trend or the rule generated therefrom. An operator action may include checking the identified trend and/or rule for its validity, or selecting one or more trends and/or rules from a list of potential trends and/or rules. The optimization procedure further includes redefining allowable actions based on the rules.

According to embodiments, the optimization procedure may include a reinforcement learning operation. Reinforcement learning may include Q-learning. The simulation result of the method 100, particularly the result of the evaluation function, may be utilized as a cost or reward measurement.

According to embodiments, the data generated by the optimization procedure may be presented to an operator to derive rules from the data. The data may include insights, which may be presented in a form similar to the following examples, which are presented herein merely for understanding and should not be understood as limitations.

For a batch digester process, such as the process described with reference to FIGS. 2A and 2B, an insight may include one or more of the following examples for patterns recognized in optimal or near-optimal schedules:

Example 1: Digester D1 and D3 have overlap of chip filling in 90% of optimal scenarios. This is irrespective of status of tank levels in various tanks.

Example 2: A tank level in impregnation tank above 70% triggers chip filling operation for digester D1 and D4 80% of the time.

For a mining operation having pits, trucks for transporting, and a crusher for processing different grades of material, an insight may include one or more of the following examples for patterns recognized in optimal or near-optimal schedules:

Example 1: Truck 1 and 3 with high tonnage follow a specific path 90% of the time together irrespective of the pit the trucks are carrying material from.

Example 2: For a specific grade, the load is directed to a specific crusher 80% of the time.

For a melt shop having cranes, furnaces for processing different grades of material, and ladles being transported by the cranes, an insight may include one or more of the following examples for patterns recognized in optimal or near-optimal schedules:

Example 1: Cranes 1 and 3 follow the same sequence of operation 80% of the time.

Example 2: For grade G1, there is no delay in loading material from the furnace 90% of the time.

According to embodiments, rules may be derived from the insights. For example, an operator may choose to define a rule stating that two or more actions that, when executed in a specific sequence, often lead to desirable outcomes should preferably or even always be executed together, thereby simplifying the model by reducing the number of potential selections of allowable actions.

According to embodiments, the rules may be integrated into the method 100 to facilitate or mask certain actions. By facilitating or masking certain actions, the number of decisions to be made during (repeated) simulation 130 may be reduced, while potentially arriving at beneficial simulation results and outputs comparable to those of a non-optimized simulation. Likewise, rules may be implemented to mask parts of the industrial process in order to simulate only a portion of the industrial process.

According to embodiments, the rules may be integrated into the method by redefining allowable actions. Redefining allowable actions may include modifying the state and action matrix, the feasibility matrix and/or the parameter matrix. For example, actions that, while being considered feasible, may be identified as often resulting in undesirable simulation results, and thus be redefined as infeasible or forbidden. According to yet further embodiments, a type of fuzzy logic, such as a fuzzy logic ruleset, particularly a set of fuzzy focal elements may be implemented, e.g, particularly in the feasibility matrix, or even the state and action matrix and/or the parameter matrix.

According to embodiments, as described above for actions often resulting in undesirable states, actions that are associated with beneficial outcomes may be preferred by modifying a chance of the action of one or more resources in a predefined state to be selected. In a first example, despite multiple possible actions being selectable, the state and action matrix may be reduced to include only the action associated with the desirable outcome. According to yet further embodiments, a type of fuzzy logic, such as a fuzzy logic ruleset, particularly a set of fuzzy focal elements may be implemented, e.g, particularly in the state and action matrix, or even the feasibility matrix and/or the parameter matrix.

According to embodiments, a fuzzy logic ruleset may be based on fuzzy Dempster-Shafer modelling and/or fuzzy set theories.

Referring now to FIG. 4, an optimization engine 400 according to an embodiment is described. The optimization engine 400 is integrated into a simulator 440. The simulator 440 may be configured for performing a method of scheduling resources in an industrial process, such as method 100 described herein. The simulator 440 may particularly be configured for performing the simulation 130 as described with reference to FIG. 1. The optimization engine 400 may be configured for executing some or all of the processes and/or functions of the optimization procedure described herein, and some or all of the processes and/or functions of the optimization engine may be performed in a method described herein, particularly the optimization procedure described herein.

In the embodiment shown in FIG. 4, the optimization engine 400 includes a reinforcement learning engine 410. The reinforcement learning engine 410 may receive data from the simulator 440 to perform reinforcement learning, such as Q-learning. The data may include the data generated in operation 160, such as the selections of allowable actions and the results of the evaluation of states. The reinforcement learning engine 410 may generate, e.g. based on a number of repeated simulations, an output. The output may include a data structure, such as a Q-table. The output may include information on the quality of state-action combinations. The output may allow identifying desirable actions. The output may allow generating rules based on the desirable actions.

As shown in FIG. 4, the output of the reinforcement learning engine 410 may be presented to an operator by an operator module 430. The operator module may, for example, include a computer system, a display, and/or an input device, and may be configured for displaying the output, allowing the operator to review the output and/or identify trends, and receiving inputs from the operator to select or define rules, such as the rules described herein.

Additionally, or alternatively, the output of the reinforcement learning engine 410 may be processed in a pattern recognition engine 420. The output may be processed before presenting the output to the operator with the operator module 430. Accordingly, an output of the pattern recognition engine 420 may be presented to the operator in addition or as an alternative to the data generated by the reinforcement learning engine 410. According to embodiments, identifying trends includes processing the data generated from one or more states of the industrial process model with a pattern recognition function. The pattern recognition engine 420 may be configured for executing the pattern recognition function. The pattern recognition engine 420 may, for example, be implemented as a software including a pattern recognition algorithm to be executed on a computer system.

According to embodiments, the pattern recognition function includes a machine learning algorithm and/or an artificial intelligence algorithm. The machine learning algorithm and/or the artificial intelligence algorithm may be configured for identifying trends in data and formulating rules based on the identified trends. According to embodiments, particularly for a reinforcement learning engine 410 utilizing Q-learning, the reinforcement learning may be combined with function approximation, e.g. by using an artificial neural network as a function approximator. Likewise, fuzzy rule interpolation and/or sparse fuzzy rule-bases may be integrated into the reinforcement learning engine 410. Beneficially, the outputs obtainable by utilizing a pattern recognition engine 420 may be presentable in a human-readable form. Beneficially, rules may be formulated by the pattern recognition engine 420, i.e. the operator may be not required to formulate the rules.

As shown in FIG. 4, rules generated and/or reviewed by the operator by interacting with the operator module 430 may be selected for integration into the simulator 440. Accordingly, a selected rule may be integrated into the simulation, following an operator input and/or selection.

According to an aspect, a simulation result, such as an optimized schedule, may not be transferrable to an industrial process having a different architecture, layout and/or configuration than the modelled process. However, an optimization procedure may result in rules that are transferrable to the different industrial process. Accordingly, there is a need for a system or method that may utilize such transferrable rules.

According to embodiments, the validity of a rule may be aligned with changes in the process configuration. This may keep the rule applicable even during such changes. Beneficially, a result of the optimization procedure, e.g. a reinforcement learning procedure, may be kept intact even during changes in the process configuration. This may beneficially avoid having to fully retrain the optimization procedure, and may avoid having to explore a bigger infeasible search space.

According to embodiments, an operator may select rules, based on a non-updated process configuration, that are applicable to an updated process configuration. Likewise, rules that are applicable to the updated process configuration may be automatically selected, e.g. based on resource identifiers that are present in both the non-updated process configuration and the updated process configuration.

According to embodiments, following a change in a configuration of the industrial process model, e.g. following a change in a parameter matrix, state and action matrix, or feasibility matrix and/or the initial state, the optimization procedure is triggered. Triggering the optimization procedure may include training or re-training the optimization engine 410.

According to embodiments, integrating a new rule or changing the ruleset may include receiving an operator input. The operator input may trigger the optimization process. Likewise, an operator may trigger the optimization process independently of a change in the ruleset.

According to embodiments, a computer-implemented scheduling system for scheduling a process cycle of an industrial process is described. The scheduling system includes a user interface and a software that, when executed on the scheduling system, causes the scheduling system to perform the method according to an embodiment described herein.

According to an aspect, the scheduling system may further comprise a network interface for connecting the device to a data network, in particular a global data network. The data network may be a TCP/IP network such as Internet. The scheduling system is operatively connected to the network interface for carrying out commands received from the data network. The commands may include a control command for controlling the device to carry out a task such as (repeatedly) simulating an industrial process in a model, obtaining an optimized schedule, and/or performing an optimization procedure according to embodiments described herein. In this case, the scheduling system is adapted for carrying out the task in response to the control command. The commands may include a status request. In response to the status request, or without prior status request, the scheduling system may be adapted for sending a status information to the network interface, and the network interface is then adapted for sending the status information over the network. The commands may include an update command including update data. In this case, the scheduling system is adapted for initiating an update in response to the update command and using the update data.

The data network may be an Ethernet network using TCP/IP such as LAN, WAN or Internet. The data network may comprise distributed storage units such as Cloud. Depending on the application, the Cloud can be in form of public, private, hybrid or community Cloud.

According to a further aspect, the scheduling system further comprises a processing unit for converting data described in the context of this disclosure, particularly simulation result data and/or data generated from one or more states of the industrial process model suitable for identifying trends in the data, into a human-readable form, particularly a human-readable form suitable for allowing an operator to identify trends and/or generate rules based on the identified trends.

According to a further aspect, the scheduling system further comprises a network interface for connecting the device to a network, wherein the network interface is configured to transceive digital signal/data between the device and the data network, wherein the digital signal/data include operational command and/or information about the device or the network. According to embodiments, a computer program product is described. The computer program product includes instructions which, when the program is executed by a computer, cause the computer to carry out the method according to embodiments described herein. The computer program product may be stored on a computer-readable medium. The computer program product may be transferrable as a data signal.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of scheduling resources in an industrial process, the industrial process comprising resources comprising primary resources, wherein the primary resources are associated with a production cycle of the industrial process, the method comprising:
generating a model of the industrial process, and
simulating the industrial process in the model;
a) determining an initial state as the current state of the industrial process model;
b) selecting an allowable action from a group of possible actions for a resource;
c) determining an updated state based on the selected action, and setting the current state as the updated state;
d) repeating operations b) through c) until a final state is reached;
e) evaluating the updated states and/or the final state according to a predefined evaluation function.

2. The method according to claim 1, wherein the allowable action is selected randomly from the group of possible actions.

3. The method according to claim 1, the industrial process comprising resources comprising secondary resources, wherein the secondary resources comprise at least one state associated with a production cycle of the industrial process, and at least one state not associated with the production cycle.

4. The method according to claim 1, wherein the group of possible actions of a resource is determined from a state and action matrix associated with the resource.

5. The method according to claim 1, wherein the group of allowable actions is determined from a feasibility matrix, the feasibility matrix defining forbidden actions of a first resource depending on a state of a second resource.

6. The method according to claim 1, wherein an iteration comprising operations b) through c) corresponds to a time period.

7. The method according to claim 1, wherein determining the state of the industrial process model comprises evaluating parameters, the parameters comprising at least one of a resource capacity, a process time, a resource material balance and/or a resource energy balance.

8. The method according to claim 7, wherein the parameters are stored in a parameter matrix.

9. The method according to claim 1, further comprising:
repeatedly simulating the industrial process for a number of repeats, each repeat comprising after performing a predefined number of iterations, generating a result schedule, wherein the result schedule comprises records of the randomly selected allowable actions;
evaluating the state corresponding to the result schedule; and
selecting an optimized result schedule based on a result of the evaluation function.

10. The method according to claim 1, wherein the evaluation function comprises evaluating the state according to one or more of:
energy consumption;
material consumption;
processed material output; and/or
time required to achieve a predefined result.

11. The method according to claim 1, further comprising an optimization procedure comprising:
identifying trends in data generated from one or more states of the industrial process model, wherein identifying the trends includes presenting the data to an operator;
generating rules based on the identified trends; and
redefining allowable actions based on the rules.

12. The method according to claim 11, wherein the optimization procedure includes a reinforcement learning operation.

13. The method according to claim 11, wherein redefining allowable actions includes modifying at least one of: the state and action matrix, the feasibility matrix and/or the parameter matrix.

14. The method according to claim 11, wherein identifying trends includes processing the data with a pattern recognition function.

15. The method according to claim 14, wherein the pattern recognition function includes a machine learning algorithm and/or an artificial intelligence algorithm.

16. The method according to claim 14, wherein an output of the pattern recognition function includes a fuzzy logic ruleset, particularly a set of fuzzy focal elements.

17. The method according to claim 11, wherein the optimization procedure is executed following a trigger, the trigger comprising an operator input; and/or a change in a configuration of the industrial process model.

18. A computer-implemented scheduling system for scheduling a process cycle of an industrial process, comprising a user interface and a software that, when executed on the scheduling system, causes the scheduling system to perform a method of scheduling resources in the industrial process, the industrial process comprising resources comprising primary resources, wherein the primary resources are associated with a production cycle of the industrial process, the method comprising:
generating a model of the industrial process, and
simulating the industrial process in the model;
a) determining an initial state as the current state of the industrial process model;
b) selecting an allowable action from a group of possible actions for a resource;
c) determining an updated state based on the selected action, and setting the current state as the updated state;
d) repeating operations b) through c) until a final state is reached;
e) evaluating the updated states and/or the final state according to a predefined evaluation function.

19. The scheduling system according to claim 18, further comprising a network interface for connecting the device to a data network, wherein the scheduling system is operatively connected to the network interface for at least one of carrying out a command received from the data network and sending device status information to the data network.

20. A computer program product comprising instructions stored in tangible media which, when the program is executed by a computer, cause the computer to carry out a method of scheduling resources in an industrial process, the industrial process comprising resources comprising primary resources, wherein the primary resources are associated with a production cycle of the industrial process, the method comprising:
generating a model of the industrial process, and
simulating the industrial process in the model;
a) determining an initial state as the current state of the industrial process model;
b) selecting an allowable action from a group of possible actions for a resource;
c) determining an updated state based on the selected action, and setting the current state as the updated state;
d) repeating operations b) through c) until a final state is reached;
e) evaluating the updated states and/or the final state according to a predefined evaluation function.
